(19) United States
(12) Patent Application Publication
(10) Pub. No.: US 2003/0108125 A1
(43) Pub. Date: Jun. 12, 2003

(54) Device for improved arithmetic coding/decoding

(76) Inventor: Thomas Dombek, Suresnes (FR)

Correspondence Address: U.S. Philips Corporation, 580 White Plains Road, Tarrytown, NY, 10591, US

(21) Appl. No.: 10/308,654

(22) Filed: Dec. 3, 2002

(30) Foreign Application Priority Data
Dec. 6, 2001 (FR) 0115779

(51) Int. Cl. H04L 27/14

(52) U.S. Cl. 375/324

(57) ABSTRACT

The present invention relates to a device (40) for decoding coded digital data (1) as a function of a context given by decoded digital data, comprising means (11) for the arithmetic decoding of the coded digital data that are suitable for supplying a current decoded digital data (2), control means (13) suitable for supplying a probability (4) to the arithmetic decoding means from a context word (3), and a processing circuit (12) suitable for storing a set of lines of decoded digital data and for supplying the context word (3) from previous decoded digital data. The processing circuit is suitable for causing cyclic movement of the data within the storage means such that the accesses required for the formation of the context word are made to the same locations in the storage means, thus enabling the context word to be extracted in a regular manner.

### FIELD OF THE INVENTION

The present invention relates to a circuit for processing digital data comprising storage means suitable for storing a set of lines of digital data and extraction means suitable for supplying a context word from a set of digital data.

It also relates to a device for the arithmetic decoding of coded digital data and a device for the arithmetic coding of digital data that comprise a processing circuit of this kind.

Finally, it relates to a method of extracting context words from digital data stored in the form of a set of lines in storage means, to a method for the arithmetic decoding of coded digital data and to a method for the arithmetic coding of digital data.

It is applicable, in particular, to encoders and decoders for digital television that are designed to respectively code and decode compressed multimedia digital data of the MPEG-4 type and, more particularly, digital data representing the binary shape of video objects that are compressed by a context-based arithmetic coding technique.

### BACKGROUND OF THE INVENTION

The MPEG-4 coding standard allows video objects belonging to the same image to be coded independently. For this purpose, the shape of a video object plane is represented by a binary map. For each pixel in a virtual screen on which a video object is to be shown, a binary data or bit indicates whether or not said pixel belongs to the video object plane. Said binary data are compressed in blocks of 16 lines of 16 pixels, called macroblocks, to which a method of arithmetic coding is applied that is based on context by a principle familiar to the person skilled in the art. For each pixel in a macroblock, a probability of its belonging to the video object plane is deduced from the binary map. These probabilities are used at the time of arithmetic coding. They are calculated in such a way that the decoder too is capable of deducing them by using only pixels previously decoded.

FIG. 1 is a diagram of a method of context-based arithmetic decoding. It comprises an arithmetic decoding step CAD (11) for the decoding of an arithmetic code (1), which step is intended to supply a binary value (2) for a pixel. It also comprises a processing step PROC (12) intended to extract a context word (3) from pixels previously decoded and to produce a set of decoded pixels (5), such as a macroblock for example. It finally comprises a control step CTRL (13) intended to supply a probability (4) to the arithmetic decoding step from the context word (3). Hence, knowledge of the arithmetic code and of the context-related probability enables the binary value of a pixel to be decoded. This pixel is then used with other pixels to determine the context and probability of the next pixel.

Under the MPEG-4 standard, the context word is deduced from pixels already decoded on the principle illustrated in FIGS. 2a and 2b. FIG. 2a shows the calculation of a context word for a current pixel (20) in the case of an INTRA macroblock, which macroblock is coded by means of information coming only from itself and from two lines or columns in adjacent macroblocks. In this case the context word

$$C = {\sum }_{k} {C}_{k} \cdot {2}^{k}$$

comprises 10 Cₖ bits distributed over 3 lines, where Cₖ=0 for a transparent pixel and Cₖ=1 for an opaque pixel. FIG. 2b shows the calculation of a context word for a current pixel (20) in the case of an INTER macroblock, which macroblock is coded by motion-compensating prediction from a zone of 18 lines of 18 pixels comprising a reference macroblock. In this case the context word

$$C = {\sum }_{k} {C}_{k} \cdot {2}^{k}$$

comprises 9 Cₖ bits distributed over 5 lines, namely 2 lines of the current macroblock (21) and 3 lines of the reference macroblock (22).

The method of context-based arithmetic coding is iterative. Hence, a context word is extracted at each iteration. Since the pixels are stored in macroblocks in a memory included in the processing means, said memory (31) being for example organized into 8-bit words (32) as shown in the diagram seen in FIG. 3, the locations (33) in the memory to which access is required to retrieve the pixel values being used to form the context word change at each iteration. What is more, the number of words to which access is required in the memory may also change at the time of an iteration. Hence, the extraction of the context word on the prior art principle takes place in a non-regular manner.

### SUMMARY OF THE INVENTION

It is an object of the present invention to propose a circuit for processing digital data comprising storage means suitable for storing a set of lines of digital data and extraction means suitable for supplying a context word from a set of digital data, which circuit allows a context word to be extracted in a more regular manner.

To this end, the circuit for processing digital data according to the invention is characterized in that the extraction means comprise means for shifting the digital data after the extraction of a context word, and for rearranging said data at the end of the processing of a line of digital data.

Hence, thanks to the shifting means, the decoded digital data are shifted at each clock cycle in such a way as to enable the extraction means to access the same locations in the storage means to retrieve the pixel values used to form the context word. In the preferred embodiment, the shifting means comprise shift registers suitable for containing digital data, which registers are connected together in such a way as to permit a cyclic shift of the items of digital data in the same line of data. What is more, the rearranging means enable the decoded digital data to be reorganized when a line of data has been processed. In the preferred embodiment, the rearranging means comprise shift registers that are connected diagonally in such a way as to enable the digital data in a current line to be rearranged into a previous line at the end of the processing of the current line.

The present invention has replaced the non-regular access to data at different locations in the storage means as practiced in the prior art with a cyclic movement of the items of data within the storage means such that the accesses required for the formation of the context word are made to the same locations in the storage means. It thus becomes possible to produce fixed connections for the storage means, particularly to a probability table intended to associate a probability with a context word, thereby making the extraction of the context word a more regular process. The speed at which the data is processed is also accelerated in this way since it becomes possible for a context word to be extracted at each clock cycle. The resources required to implement a device of this kind are also minimized due to the simplicity with which the data can be extracted, and the delay times too are reduced.

Another object of the present invention is a device for the arithmetic decoding of coded digital data and a device for the arithmetic coding of digital data that comprise a processing circuit of this kind, to enable the context word used for the determination of a probability required for the arithmetic decoding/coding to be extracted in a more regular manner.

Another object of the present invention is a decoder of coded multimedia digital data, particularly of the MPEG-4 type, that comprises a decoding device of this kind, and an encoder of multimedia digital data that comprises a coding device of this kind, which decoder and encoder are more efficient.

A final object of the present invention is to propose a method of extracting context words from digital data stored in the form of a set of lines in storage means, a method for the arithmetic decoding of coded digital data and a method for the arithmetic coding of digital data, which methods also employ more regular extraction of a context word.

### BRIEF DESCRIPTION OF THE DRAWINGS

These and other aspects of the invention are apparent from and will be elucidated with reference to the embodiments described hereinafter, which are given by way of non-limiting example.

In the drawings:

FIG. 1 is a general diagram of a method of context-based arithmetic decoding.

FIG. 2a shows the calculation of a context word in the case of an INTRA macroblock.

FIG. 2b shows the calculation of a context word in the case of an INTER macroblock.

FIG. 3 shows the organization of a memory included storage and processing means according to the prior art.

FIG. 4 shows a context-based arithmetic decoding device according to the invention.

FIG. 5 shows the principle on which the lines of a macroblock are processed in accordance with the invention.

FIG. 6 shows an MPEG-4 decoder that incorporates a context-based arithmetic decoding device according to the invention.

FIG. 7 shows a context-based arithmetic coding device, and

FIG. 8 shows an MPEG-4 encoder that incorporates a context-based arithmetic coding device.

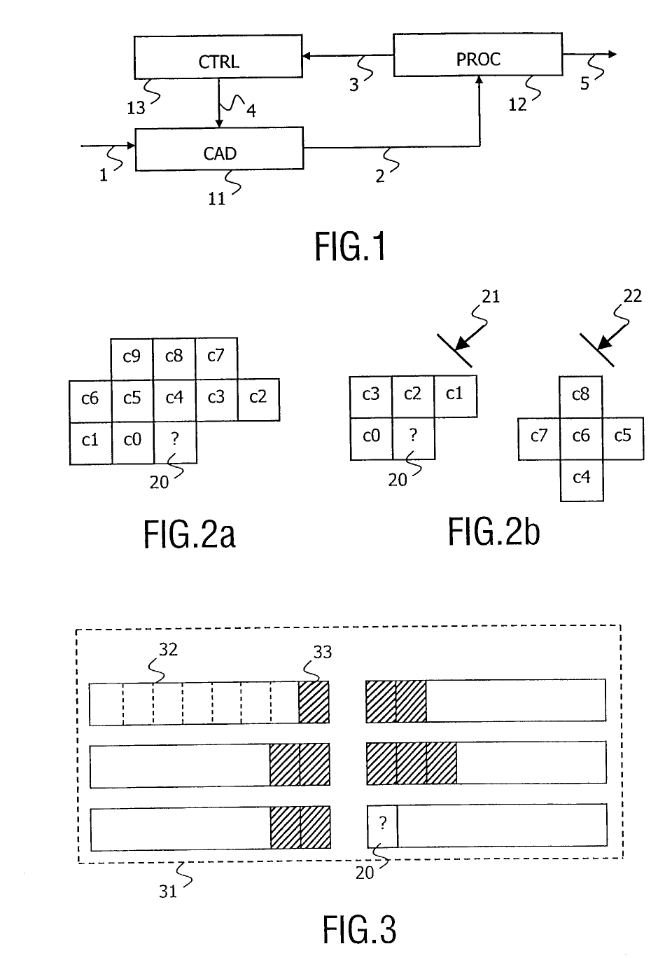

### DETAILED DESCRIPTION OF AT LEAST ONE EMBODIMENT OF THE INVENTION

The present invention relates to a circuit for processing digital data. It was developed in the context of the context-based arithmetic coding/decoding of digital video data of the MPEG-4 type representing the binary shape of a video object plane (VOP) but is applicable to applications of other types where the aim is for a context word to be extracted in a regular manner from a set of binary or non-binary digital data that are stored in a memory, by virtue of a cyclic movement of the data within a memory.

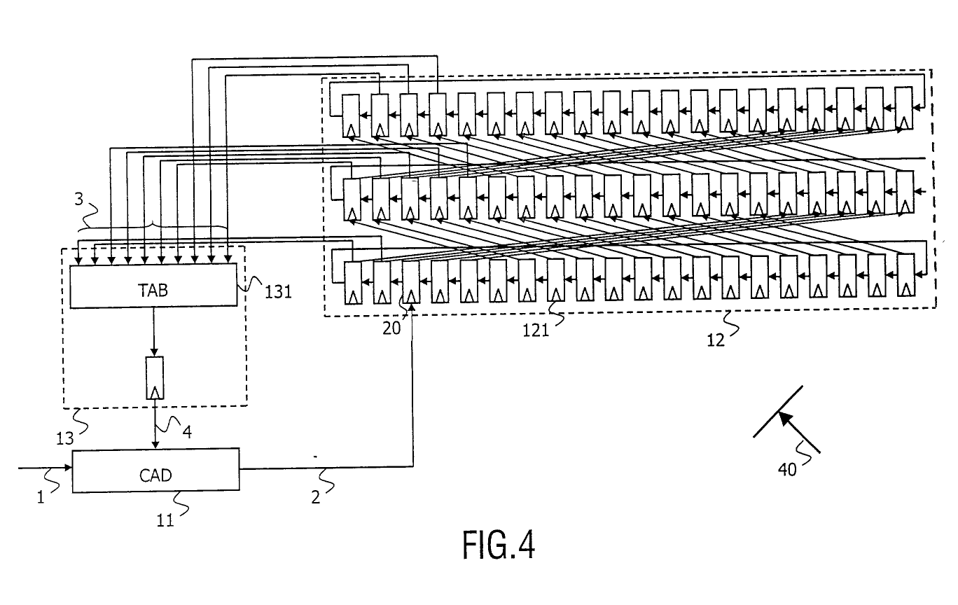

FIG. 4 shows a context-based arithmetic decoding device (40) according to the invention. The decoding device is suitable for decoding coded digital data or arithmetic code (1) as a function of a context given by decoded digital data, which in this case is the binary values of pixels that indicate whether or not the pixels belong to a video object plane. For this purpose it comprises:

means CAD (11) for the arithmetic decoding of coded digital data, which are suitable for supplying a binary value for a current pixel (2), on a principle familiar to the person skilled in the art,

a circuit (12) for processing digital data that comprises storage means suitable for storing a set of lines of pixels and extraction means suitable for supplying a context word (3) from a set of values of previous pixels,

control means (13) suitable for supplying a probability (4) to the arithmetic decoding means from the context word (3), a probability table TAB (131) giving the correspondence between a context word and a probability.

The storage means are intended to save the binary values of pixels that are required for the decoding or that result from the decoding, between two consecutive clock cycles. In the preferred embodiment, said means comprise a two-dimensional network of shift registers (121), with each register representing one pixel. The storage means are constructed so as to contain the data immediately required for decoding purposes, or are suitable for containing a larger quantity of data, thus acting as a cache memory for other storage media having longer delay times.

The binary values required for decoding are initially loaded into the storage means. The storage means are suitable for containing at least a few lines from a macroblock of pixels and from macroblocks adjacent to said macroblock to allow for the structure of a context word. In the case of an INTRA macroblock, at least 3 lines of 20 pixels are required, whereas in the case of an INTER macroblock, at least 5 lines of 20 pixels are required, these being 2 lines of a current macroblock and 3 lines of a reference macroblock. The storage means may equally well contain an entire macroblock and fractions of adjacent macroblocks, that is to say a zone of 20 lines of 20 pixels in the case of the current INTRA or INTER macroblock and a zone of 18 lines of 18 pixels in the case of the reference macroblock. It goes without saying that the invention is not limited to sizes of this kind for the storage means. It is for example possible to optimize the number of shift registers per line by taking into account the fact that, on the one hand, certain shift registers are initially empty (they are filled by the data that are subsequently decoded) and that, on the other hand, the content of certain registers becomes obsolete during the decoding (such as, for example, the values of pixels in the reference zone once the decoding has taken place). If provision is made for the pre-loading of the reference zone of 18 lines of 18 pixels, it is in particular possible for the obsolete data at locations where this zone is stored to be gradually replaced by the data that are decoded.

The storage means form part of the processing circuit (12), sometimes referred to as a context operator, and the shift registers are connected together in such a way as to allow the binary pixel values belonging to the same line to be shifted cyclically. The shift registers are also connected diagonally in such a way as to enable the items of digital data in a current line to be rearranged into a previous line at the end of the processing of the current line. The processing circuit also comprises a global controller that is suitable for selecting between the shifting means and the rearranging means by multiplexing the various inputs to the shift registers. The shift registers thus have fixed connections to the probability table (131) of the control means in such a way as to supply the table with the context word (3). FIG. 4 shows the extraction of a 10-bit context word in the case of an INTRA macroblock. The extraction of a 9-bit context word in the case of an INTER macroblock is not described here but is performed on a similar principle with at least 5 lines of binary values.

The digital data may be processed line by line or column by column. Only line-by-line processing will be looked at in what follows, the second mode of processing being similar to the first in the sense that it can be performed by, for example, making the digital data symmetrical about the diagonal of a macroblock.

The processing of the lines in a macroblock is performed according to the principle shown in FIG. 5. The shift registers (121) that are shaded correspond to the pixels in macroblocks adjacent to the current macroblock. In the initial configuration (51), a line of 16 pixels from a current macroblock is contained between two pixels from a previous macroblock and two pixels from a subsequent macroblock. During the first 15 clock cycles, the pixels are shifted to the left in the direction of the adjacent shift register. The cyclic shift takes place only for those lines whose shift registers are connected to the probability table (131) of the control means. The sixteenth clock cycle takes place at the end of the processing of a current line. The digital data in the current line (52), which is shown as it is in the fifteenth clock cycle, is then transferred diagonally to the shift registers for the previous line (53), which is shown here as it is in the sixteenth clock cycle, thus restoring the original structure where there was a line of 16 pixels from a current macroblock contained between two pixels from a previous macroblock and two pixels from a subsequent macroblock. These cyclic and diagonal movements are then repeated regularly every 16 clock cycles.

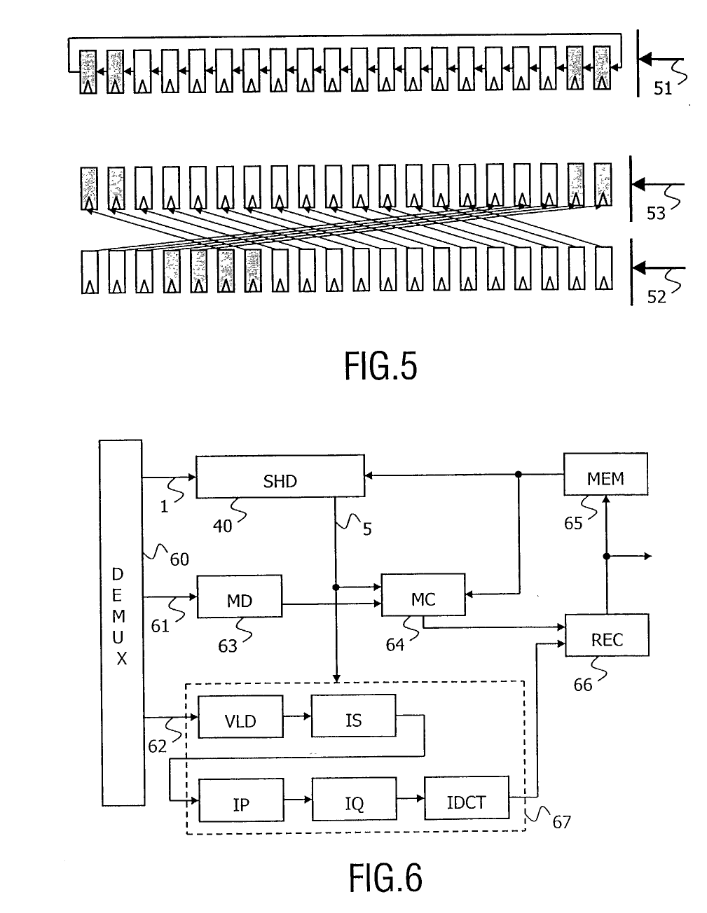

FIG. 6 shows an MPEG-4 decoder incorporating a context-based arithmetic decoding device of this kind.

The MPEG-4 decoder comprises a demultiplexing circuit DEMUX (60) suitable for separating the multiplexed coded multimedia data into an arithmetic code (1) for the binary shape of a VOP, into coded data for motion (61) and into coded data for texture (62). The MPEG-4 decoder comprises three main parts for decoding these different types of data:

a context-based arithmetic decoding device SHD (40) as described above, which is suitable for decoding the arithmetic code (1) into values for binary shape (5),

a motion decoder MD (63) that is followed by a motion compensator MC (64),

a decoder (67) for decoding coded texture data,

A video object plane VOP is reconstructed macroblock by macroblock, by means of reconstruction means REC (66), by combining the decoded information for binary shape, for motion and for texture. The video object plane is stored temporarily in an image memory MEM (65).

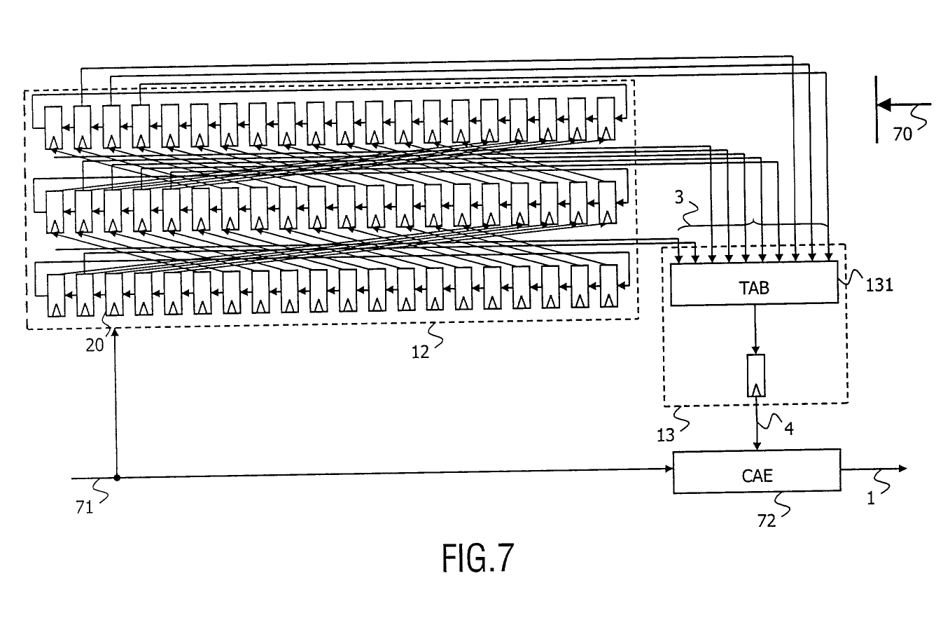

FIG. 7 shows a context-based arithmetic coding device (70) according to the invention. The coding device is suitable for coding binary values of pixels (71) as a function of a context for said pixels. For this purpose it comprises:

means CAE (72) for the arithmetic coding of the binary values that are suitable for supplying an arithmetic code (1),

a processing circuit (12) as described above that is suitable for storing a set of lines of binary values for pixels and of supplying a context word (3) for the binary value of a current pixel from a set of binary values for previous pixels,

control means (13) that are suitable for supplying a probability (4) to the arithmetic coding means from the context word (3) and from a probability table TAB (131), the shift registers in the processing circuit being connected to the probability table (131) by fixed connections.

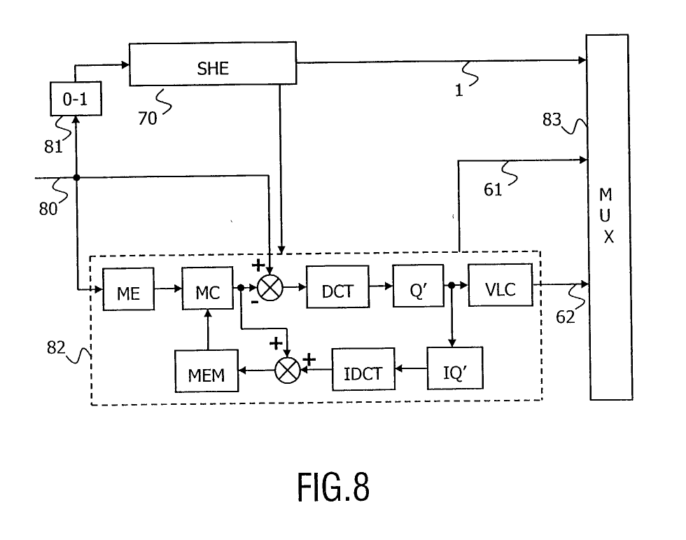

FIG. 8 shows an MPEG-4 encoder that incorporates a context-based arithmetic coding device of this kind. The principle on which the MPEG-4 encoder operates is as follows. A video object plane VOP is divided into macroblocks (80). The values representing the binary shape of the video object plane are determined (81) and then coded by a context-based arithmetic coding device (70) as described above, which supplies an arithmetic code (1) to a multiplexer MUX (83). Motion estimation ME and motion compensation MC are performed by using previous or subsequent video image planes as reference images. The residual error between a current video object plane and a reference video object plane is calculated and then coded by a texture encoder (82) that supplies coded information on motion (61) and texture (62) to the multiplexer.

The extraction of the context word (3) from digital data stored in the form of a set of lines in the storage means may also take place in the form of a method that comprises the steps of shifting the digital data after the extraction of a context word, and of rearranging said data at the end of the processing of a line of digital data.

Similarly, the decoding of coded digital data (1) as a function of a context given by decoded digital data may take place in the form of a method comprising the steps of decoding the coded digital data arithmetically, which step is intended to supply a current decoded digital data (2), of storing a set of lines of decoded digital data, of extracting as described above a context word (3) from previous decoded digital data, and of controlling, which step is intended to supply a probability (4) to the arithmetic decoding step from the context word (3).

Finally, the coding of digital data (71) as a function of the context of said data may take place in the form of a method comprising the steps of coding the digital data arithmetically, which step is intended to supply coded digital data (1), of storing a set of lines of digital data, of extracting as described above a context word (3) for a current item of digital data from a previous set of digital data, and of controlling, which step is intended to supply a probability (4) to the arithmetic coding step from the context word (3).

No reference numeral in parentheses in the present text should be interpreted as a limitation. The verb “comprise” and its conjugated forms should also be interpreted in the broad sense, i.e. as not excluding the presence not only of items or steps other than those listed after said verb but also of a plurality of items or steps that are already listed after said verb and are preceded by the word “a” or “an”.

1. A circuit (12) for processing digital data comprising storage means suitable for storing a set of lines of digital data and extraction means suitable for supplying a context word (3) from a set of digital data, said circuit being characterized in that the extraction means comprise means for shifting the digital data after the extraction of a context word, and for rearranging said data at the end of the processing of a line of digital data.

2. A circuit for data processing as claimed in claim 1, characterized in that the shifting means comprise shift registers suitable for containing digital data, which shift registers are connected together in such a way as to enable the digital data in the same line of data to be shifted cyclically.

3. A circuit for processing data as claimed in claim 1 or 2, characterized in that the rearranging means comprise shift registers that are connected diagonally in such a way as to enable the digital data in a current line to be rearranged into a previous line at the end of the processing of the current line.

4. A device (40) for decoding coded digital data (1) as a function of a context given by decoded digital data, comprising:
means (11) for the arithmetic decoding of the coded digital data that are suitable for supplying a current decoded digital data (2),
control means (13) suitable for supplying a probability (4) to the arithmetic decoding means from a context word (3),
said device being characterized in that it comprises a processing circuit (12) as claimed in claim 1, which is suitable for storing a set of lines of decoded digital data and for supplying the context word (3) from previous decoded digital data.

5. A device (70) for coding digital data (71) as a function of a context given by said data, comprising:
means (72) for the arithmetic coding of digital data that are suitable for supplying coded digital data (1),
control means (13) suitable for supplying a probability (4) to the arithmetic coding means from a context word (3),
said device being characterized in that it comprises a processing circuit (12) as claimed in claim 1 that is suitable for storing a set of lines of digital data and for supplying a context word (3) for a current item of digital data from a set of previous digital data.

6. A decoder of multimedia digital data, particularly of the MPEG-4 type, comprising a decoding device as claimed in claim 4 that is suitable for decoding coded digital data representing a binary shape from the multimedia digital data.

7. An encoder for multimedia digital data particularly of the MPEG-4 type, comprising a coding device as claimed in claim 5 that is suitable for coding digital data representing a binary shape from the multimedia digital data.

8. A method of extracting context words (3) from digital data stored in the form of a set of lines in storage means, characterized in that it comprises the steps of shifting the digital data after the extraction of a context word, and of rearranging said data at the end of the processing of a line of digital data.

9. A method of decoding coded digital data (1) as a function of a context given by decoded digital data, comprising the steps of:
arithmetic decoding of the coded digital data, which step is intended to supply a current decoded digital data (2),
storing a set of lines of decoded digital data,
extracting a context word (3) from previous decoded digital data,
controlling, which step is intended to supply a probability (4) to the arithmetic decoding step from the context word (3),
said method being characterized in that the extraction step comprises the sub-steps of shifting the decoded digital data after the extraction of a context word, and of rearranging said data at the end of the decoding of a line of digital data.

10. A method of coding digital data (71) as a function of a context given by said data, comprising the steps of:
arithmetic decoding of the digital data, which step is intended to supply coded digital data (1),
storing a set of lines of digital data,
extracting a context word (3) for a current digital data from a set of previous items of digital data,
controlling, which step is intended to supply a probability (4) to the arithmetic decoding step from the context word (3),
said method being characterized in that the extraction step comprises the sub-steps of shifting the digital data after the extraction of a context word, and of rearranging said data at the end of the coding of a line of digital data.
